(19) United States
(12) Patent Application Publication
(10) Pub. No.: US 2025/0336259 A1
(43) Pub. Date: Oct. 30, 2025

(54) ELECTRONIC GAMING SYSTEMS AND METHODS FOR TRIGGERING MULTIPLE METAMORPHIC FEATURES

(71) Applicant: Aristocrat Technologies, Inc., Las Vegas, NV (US)

(72) Inventors: Daniel Marks, Decatur, GA (US); Hua Xu, Marietta, GA (US)

(21) Appl. No.: 18/649,421

(22) Filed: Apr. 29, 2024

(51) Int. Cl. G07F 17/32

(52) U.S. Cl. CPC G07F 17/3213; G07F 17/3267

(57) ABSTRACT

A system for electronic gaming is provided. The system is configured to: (1) generate a first random outcome for a first reel of an electronic game, the random outcome including a single-triggering symbol associated with a first metamorphic feature, (2) generate a second random outcome for a second reel of the electronic game, the second random outcome including a multi-triggering symbol, the multi-triggering symbol associated with the first metamorphic feature and at least one other metamorphic feature, each of the metamorphic features associated with a visual change in the electronic game indicating the metamorphic feature is active, (3) for each of the metamorphic features associated with the multi-triggering symbol, determine whether to activate the metamorphic feature based on a respective RNG outcome, and (4) for the first metamorphic feature associated with the single-triggering symbol, determine whether to activate the first metamorphic feature based on a respective RNG outcome.

### TECHNICAL FIELD

The field of disclosure relates generally to electronic gaming, and more specifically, to electronic gaming systems and methods that include displaying multi-triggering symbols during game play wherein the multi-triggering symbols trigger multiple metamorphic features within the electronic game.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, a system for electronic gaming is provided. The system includes at least one memory device and at least one processor in communication with the memory device. The at least one processor is configured to generate a first random outcome for a first reel of an electronic game. The first random outcome may include a single-triggering symbol associated with a first metamorphic feature. The at least one processor may be further configured to generate a second random outcome for a second reel of the electronic game, the second random outcome including a multi-triggering symbol. The multi-triggering symbol may be associated with the first metamorphic feature and at least one other metamorphic feature. Each of the metamorphic features may be associated with a visual change in the electronic game indicating the metamorphic feature is active. The at least one processor may be further configured to, for each of the metamorphic features associated with the multi-triggering symbol, determine whether to activate the metamorphic feature based on a respective RNG outcome. The at least one processor may be further configured to, for the first metamorphic feature associated with the single-triggering symbol, determine whether to activate the first metamorphic feature based on a respective RNG outcome. The at least one processor may be further configured to, for each activated metamorphic feature, control a display device to display the visual change associated with the activated metamorphic feature based on the respective RNG outcomes.

In another aspect, at least one non-transitory computer-readable storage media having computer-executable instructions embodied thereon is provided. When executed by at least one processor in communication with at least one memory device, the computer-executable instructions may cause the at least one processor to generate a random outcome for an electronic game. The random outcome may include a single-triggering symbol associated with a first metamorphic feature and a multi-triggering symbol. The multi-triggering symbol may be associated with the first metamorphic feature and at least one other metamorphic feature. Each of the metamorphic features may be associated with a visual change in the electronic game indicating the metamorphic feature is active. The computer-executable instructions may further cause the at least one processor to, for each of the metamorphic features associated with the multi-triggering symbol included in the random outcome, determine whether to activate the metamorphic feature based on a respective RNG outcome. The computer-executable instructions may further cause the at least one processor to, for the first metamorphic feature associated with the single-triggering symbol included in the random outcome, determine whether to activate the first metamorphic feature based on a respective RNG outcome. The computer-executable instructions may further cause the at least one processor to, for each activated metamorphic feature, control a display device to display the visual change associated with the activated metamorphic feature based on the respective RNG outcomes.

In another aspect, a method for electronic gaming is provided. The method includes generating a random outcome for an electronic game. The random outcome may include a single-triggering symbol associated with a first metamorphic feature and a multi-triggering symbol. The multi-triggering symbol may be associated with the first metamorphic feature and at least one other metamorphic feature. Each of the metamorphic features may be associated with a visual change in the electronic game indicating the metamorphic feature is active. The method may further include, for each of the metamorphic features associated with the multi-triggering symbol included in the random outcome, determining whether to activate the metamorphic feature based on a respective random number generator (RNG) outcome. The method may further include, for the first metamorphic feature associated with the single-triggering symbol included in the random outcome, determining whether to activate the first metamorphic feature based on a respective RNG outcome. The method may further include, for each activated metamorphic feature, controlling a display device to display the visual change associated with the activated metamorphic feature based on the respective RNG outcomes.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a flowchart illustrating an exemplary process for electronic gaming using a multi-triggering symbol according to an embodiment of the present disclosure.

FIG. 5 is a flowchart illustrating an exemplary process for electronic gaming using a multi-triggering symbol in which a single-triggering symbol may be converted or upgraded to a multi-triggering symbol according to an embodiment of the present disclosure.

FIG. 6 depicts an exemplary game interface according to an embodiment of the present disclosure.

FIG. 7 depicts another exemplary game interface according to an embodiment of the present disclosure.

FIG. 8 depicts an example weighted table according to an embodiment of the present disclosure.

### DETAILED DESCRIPTION

Described herein are electronic gaming systems and methods that include using multi-triggering symbols that are displayed during game play within a symbol matrix to trigger multiple metamorphic features in the electronic game. As described herein, the multi-triggering symbol may be a single symbol displayed within a single display position on the matrix that visually indicates that it is triggering more than one metamorphic feature. In the exemplary embodiment, the electronic game may include a plurality of metamorphic features. When a multi-triggering symbol is displayed, a random determination may be made separately for each metamorphic feature associated with the multi-triggering symbol. Based on the determination for each metamorphic feature, a corresponding game feature and display outcome may be triggered. These game features may include, for example, a game mechanic, bonus feature, and/or bonus game. The display outcome may include a visual change in the game display that may indicate to a user that the metamorphic feature and corresponding game feature is activated. Examples of metamorphic features may include eligibility for jackpots or prizes, eligibility for bonus features and/or bonus games, multipliers, free spins, boost, and/or other game mechanics that may be added on top of base gameplay of the electronic game.

Metamorphic features may be triggered based on a base game outcome. For example, a trigger symbol may be displayed in the game outcome, and in response to the triggering symbol being displayed, a random determination may be made (e.g., using a random number generator (RNG) to determine to activate a metamorphic feature that is associated with the trigger symbol. In some implementations, one type of triggering symbol, referred to herein as a “single-triggering symbol,” may be associated with and potentially trigger one of the plurality of metamorphic features that has a predefined association with the single-triggering symbol. Accordingly, different types of single-triggering symbol may trigger different corresponding metamorphic features. Because each single-triggering symbol may have a relatively small probability of being displayed in a given game outcome and triggering a metamorphic feature, a chance of multiple metamorphic features being triggered based on an appearance of single-triggering symbols during the given game outcome is even smaller.

The system described herein may reduce a complexity in generating a random game outcome that provides a chance to trigger some or all of the different metamorphic features presented within a game. In one exemplary implementation, the system may generate a game outcome including another type of triggering symbol, referred to herein as a “multi-triggering symbol,” that corresponds to multiple different metamorphic features. The multi-triggering symbol is designated with a predefined association to specific metamorphic features, and enables the features to be triggered without necessarily landing the different types of single-triggering symbols corresponding to each of the different metamorphic features. Additionally, or alternatively, the system may upgrade a single-triggering symbol by performing an RNG call that provides an opportunity to trigger other metamorphic features. For example, the single-triggering symbol may be converted to a multi-triggering symbol associated with multiple metamorphic features, or a multi-triggering symbol that is associated with a first number of metamorphic features may be converted to a multi-triggering symbol that is associated with a greater number of metamorphic features.

A technical problem exists in enabling gaming devices to improve an ability to control randomly landing triggering symbols within a single game outcome to trigger multiple metamorphic features. In a conventional game with multiple metamorphic features, the game may land a single-triggering symbol that is associated with only one of the metamorphic features. For example, a game may have a red, a blue, and a green colored metamorphic feature. To have an opportunity to trigger the red colored metamorphic feature, the red triggering symbol needs to land; to trigger the blue colored metamorphic feature, the blue triggering symbol needs to land; and to trigger the green colored metamorphic feature, the green triggering symbol needs to land. If a given triggering symbol lands, an RNG call may be performed to determine whether the corresponding metamorphic feature is triggered.

As the number of metamorphic features presented within a game starts to increase, for example, to four, five, or six metamorphic features, having a game outcome that lands all the different colored triggering symbols becomes more difficult (i.e., lower probability) given the random nature of the gaming environment. As an example, if a game has six different metamorphic features that correspond to six different triggering symbols, the game will need to generate an outcome that lands all six triggering symbols to provide a player a chance/opportunity to trigger all six metamorphic features. The probability to trigger all six metamorphic features is even lower since landing a triggering symbol does not necessarily guarantee triggering the metamorphic feature. In current games, given the random nature of generating a game outcome, the game designer is limited on how to go about controlling the rates of providing a player the opportunity to the trigger the metamorphic features.

The disclosed system is technically rooted in gaming technology that generates opportunities to trigger multiple metamorphic features. In one implementation, the game may land a multi-triggering symbol that corresponds to multiple metamorphic features. The multi-triggering symbol may provide an opportunity to trigger specific metamorphic features without landing the different types of single-triggering symbols. As an example, the multi-triggering symbol may be a multi-colored symbol with three different colors, red, blue, green, where each color is linked to a different metamorphic feature. Specifically, the red color may be linked to a red metamorphic feature; the blue color may be linked to a blue metamorphic feature; and the green color may be linked to a green metamorphic feature. The multi-color symbols may vary in the number of colors, for example, 2, 3, 4, 5, etc. colors. The system may also generate single-triggering symbols, for example single-colored symbols that would be linked to the different colored metamorphic features.

Additional or alternatively, the system may upgrade a single-triggering symbol, for example, by performing an RNG call or determining a certain predefined reel pattern is displayed, which provides an opportunity to trigger other metamorphic features. If the system (e.g., randomly) determines to upgrade the single-triggering symbol, the single-triggering symbol can randomly activate additional metamorphic features not assigned to the single-triggering symbol. As an example, a red, single-triggering symbol may land. The system may perform an RNG call to determine that the red triggering symbol should be upgraded to provide an opportunity to trigger the blue and green metamorphic features. The determination to upgrade a triggering symbol may be done in the background or presented to a player, for example, using a wheel or other visual indicator.

The technical problems addressed herein include: (i) inability for known electronic games that includes multiple metamorphic features to simultaneously trigger more than one of the metamorphic features due to there being a limited number of predefined positions in which a triggering symbol can be displayed; (ii) inability for known electronic games that includes multiple metamorphic features to simultaneously trigger more than one of the metamorphic features while maintaining a relatively low probability that any one of the metamorphic features is displayed in a given game instance; and/or (iii) limited degrees of randomness that may be used to determine when metamorphic features are triggered in known electronic games.

The resulting technical effect and/or technical benefits achieved herein include at least one of: (i) ability in electronic games that includes multiple metamorphic features to simultaneously trigger more than one of the metamorphic features by displaying a triggering symbol with a predefined association with multiple metamorphic features; (ii) ability for known electronic games that includes multiple metamorphic features to simultaneously trigger more than one of the metamorphic features while maintaining a relatively low probability that any one of the metamorphic features is displayed in a given game instance by displaying a triggering symbol with a predefined association with multiple metamorphic features; and/or (iii) providing more degrees of randomness that may be used to determine when metamorphic features are triggered in an electronic game by providing triggering symbols that may be randomly upgraded to be associated more than one metamorphic feature that can be triggered by the triggering symbol.

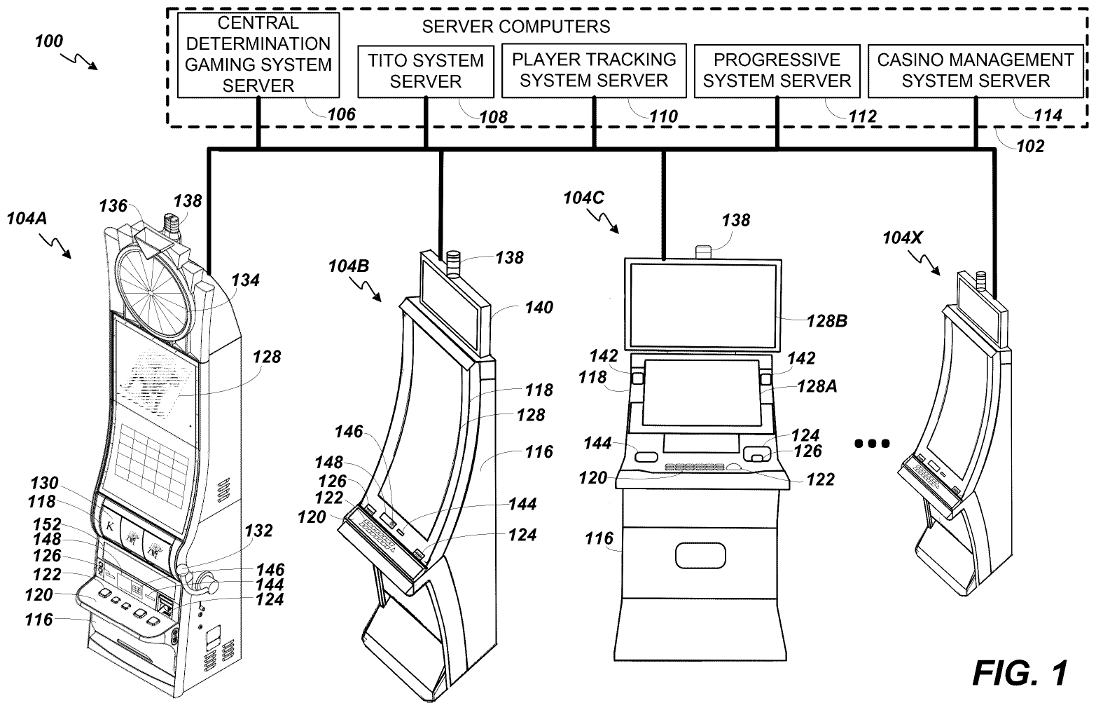

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat& Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

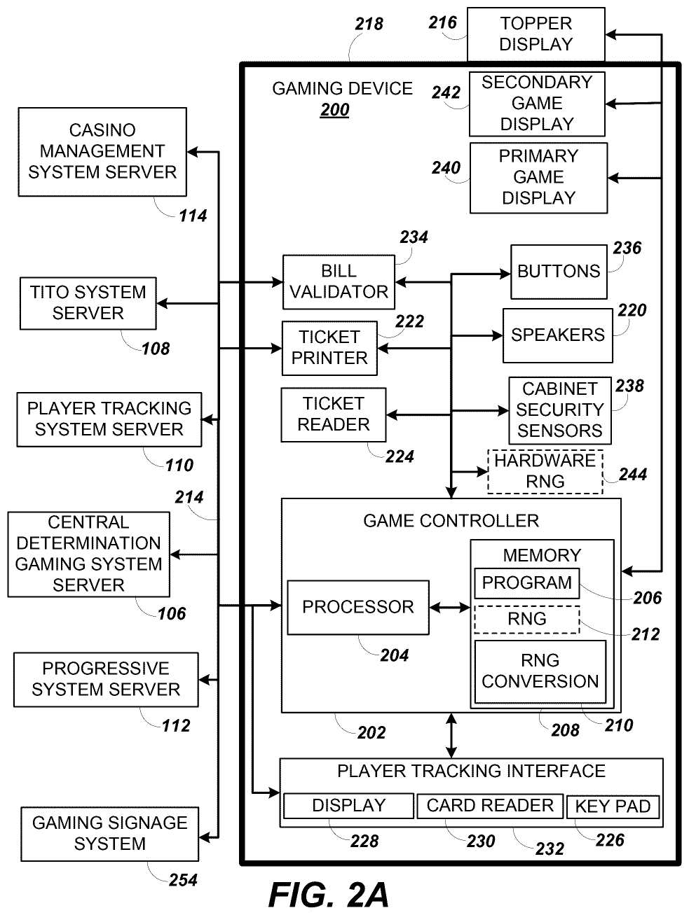

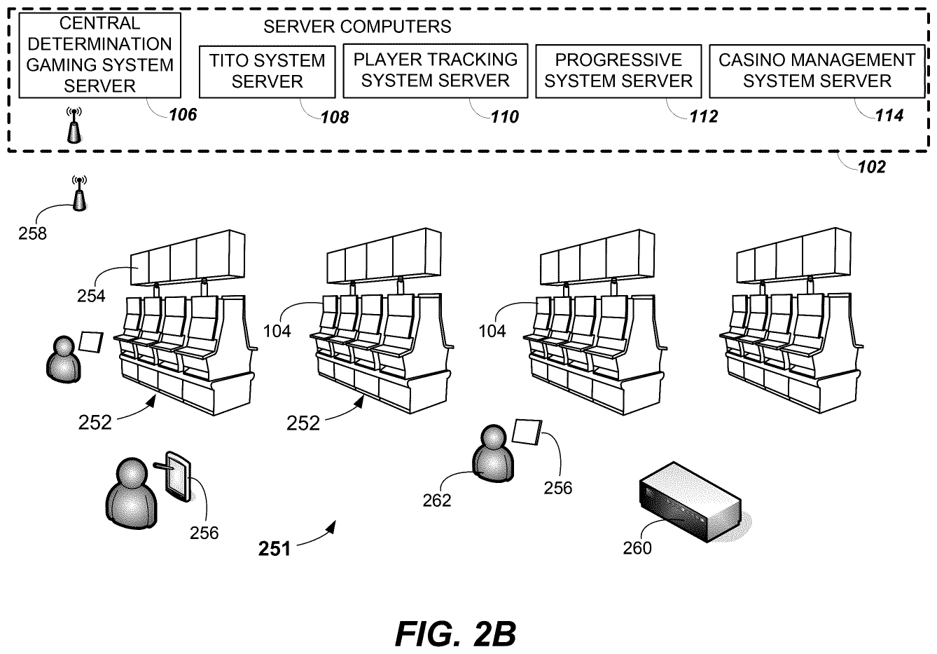

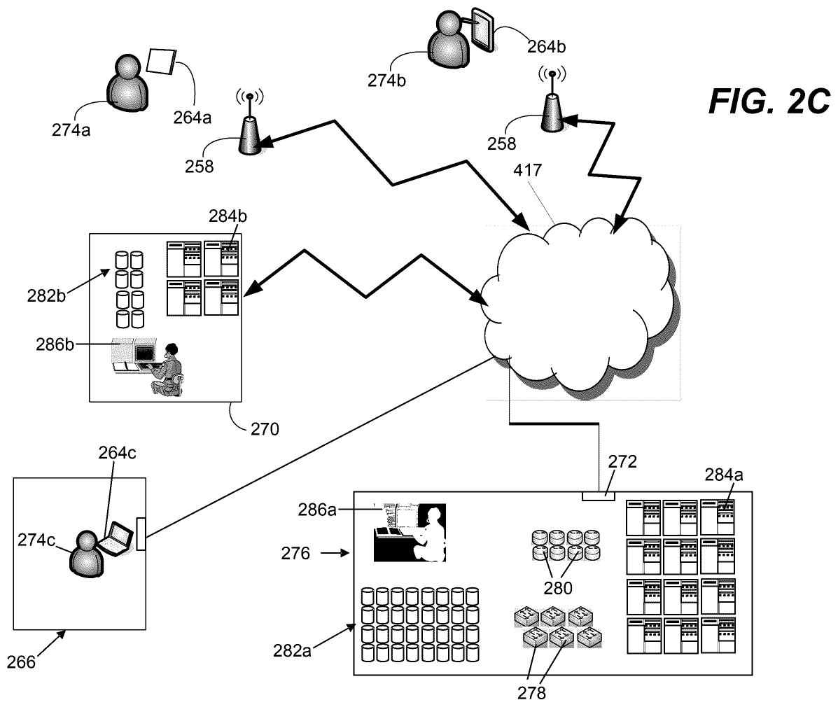

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat& Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat& Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

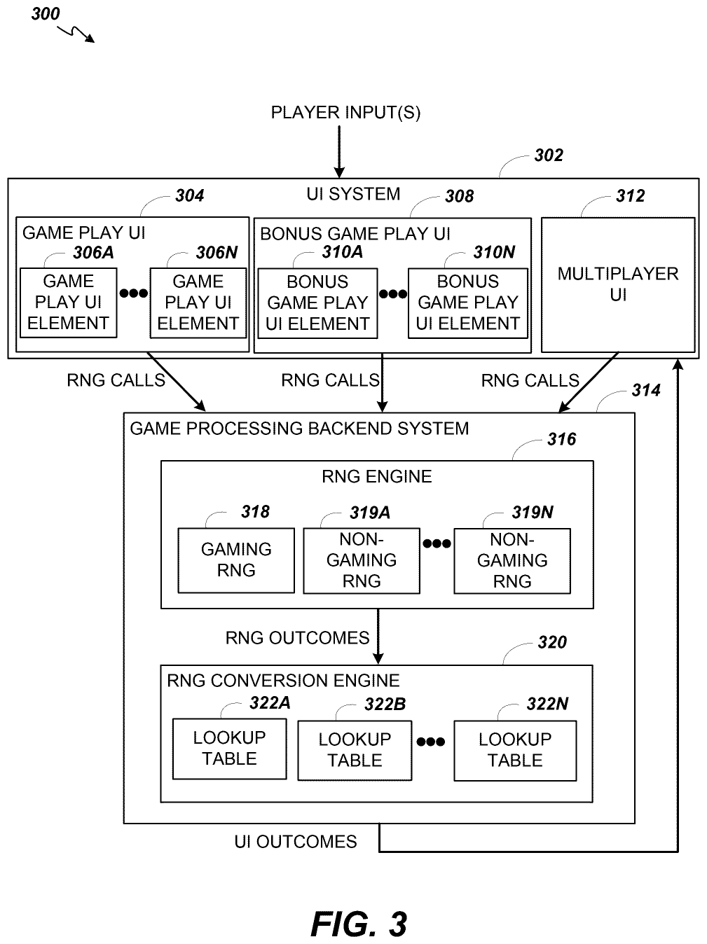

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

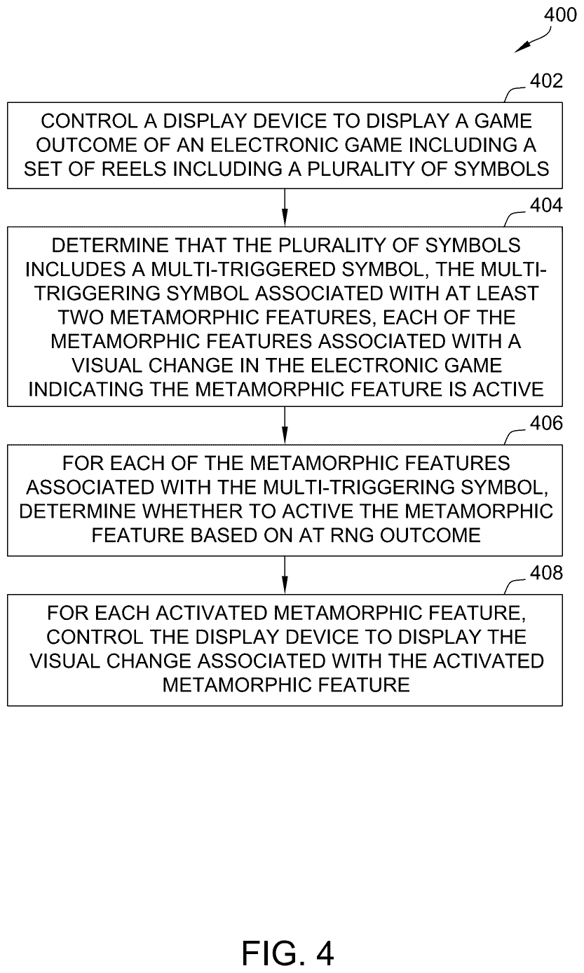

FIG. 4 is a flowchart illustrating an exemplary process 400 for electronic gaming using a multi-triggering symbol that may trigger multiple metamorphic features. Process 400 may be performed by system 100 (shown in FIG. 1), for example, using one or more server computers 102, gaming devices 104, and/or mobile gaming devices 256 (shown in FIG. 2).

In the exemplary embodiment, process 400 may include controlling 402 a display device (e.g., game displays 240 and 242) to display a game outcome of the electronic game. The game outcome may include a set of reels including a plurality of symbols, for example, displayed in respective matrix positions of the reels. The game outcome may be determined randomly, for example, by performing a lookup using one or more pay tables based on one or more RNG outcomes.

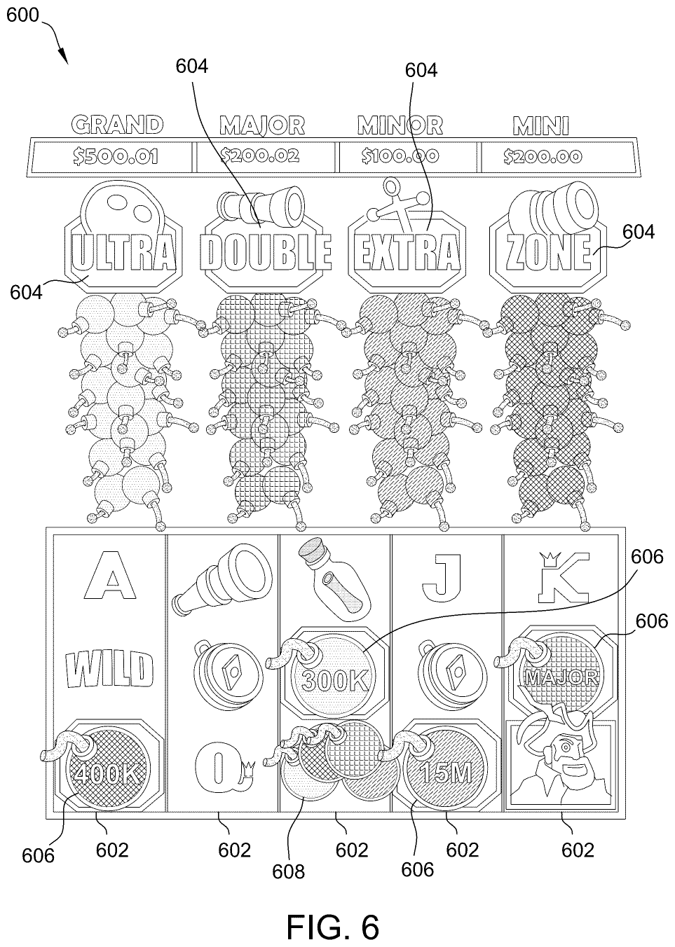

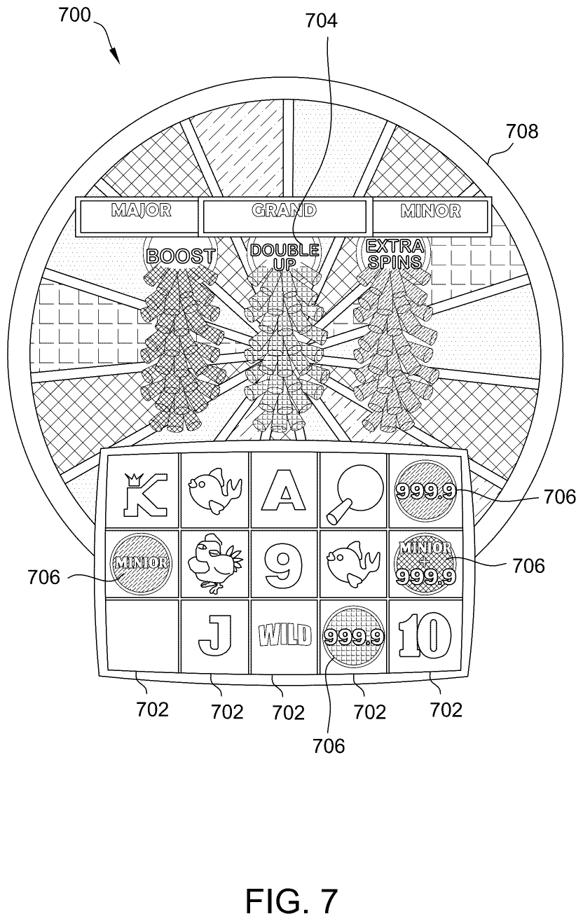

In the exemplary embodiment, the electronic game may include one or more metamorphic features. When a metamorphic feature is activated, a certain game mechanic and visual change in the game display may be triggered. The visual change may indicate to a user that the metamorphic feature and corresponding game mechanic is activated. Examples of metamorphic features may include eligibility for jackpots or prizes, eligibility for bonus features, multipliers, free spins, boost, and/or other game mechanics that may be added on top of base gameplay of the electronic game. Examples of visual changes may include overlays and/or changes to a background of the game display (e.g., changing images, changing colors, highlighting portions of the display. Some examples of visual changes are shown in FIGS. 6 and 7, which are described in further detail below.

In the exemplary embodiment, activation of these metamorphic features may be triggered in part by an appearance of a corresponding triggering symbol in the game outcome. For example, when the game outcome includes a triggering symbol associated with a certain metamorphic feature, a random determination may be made (e.g., based on an RNG outcome) to determine whether to activate that metamorphic feature. If more than one triggering symbol is displayed in the game outcome, each triggering symbol may be evaluated separately in parallel.

In some embodiments, an appearance or display aspect of the triggering symbol may indicate or otherwise be associated with the corresponding metamorphic feature. For example, a color of and/or included in the triggering symbol may be associated with a particular metamorphic feature. Additionally, or alternatively, the triggering symbol may not include any visual indicator of which metamorphic feature is associated with the triggering symbol, thus enabling, for example, the metamorphic feature that may be activated to be a surprise to the user. A predefined association between the triggering symbol and the corresponding metamorphic feature may be maintained even if the triggering symbol does not include a display aspect that identifies the corresponding metamorphic feature. As described in further detail below, the triggering symbols that can be displayed may include both single-triggering symbols that are associated with one metamorphic feature and multi-triggering symbols that are associated with more than one metamorphic feature. Multi-triggering symbols may include a display aspect (e.g., color) associated with each of the corresponding metamorphic features.

In the exemplary embodiment, process 400 may further include determining 404 that the plurality of symbols of the displayed game outcome includes a multi-triggering symbol. The multi-triggering symbol may be associated with at least two metamorphic features, which, as described above, may each by associated with a corresponding visual change in the electronic game indicating the metamorphic feature is active. In some embodiments, one of the multi-triggering symbols may be associated with two metamorphic features, three metamorphic features, four metamorphic features, or more, with a possibility of different multi-triggering symbols with different numbers of associated metamorphic features appearing.

In the exemplary embodiment, process 400 may further include, for each of the metamorphic features associated with the multi-triggering symbol that is displayed, determining 406 whether to activate the metamorphic feature based on a respective RNG outcome. For example, a displayed multi-triggering symbol may be associated with three metamorphic features: red, green, and blue. For each of red, green, and blue, a separate RNG call may be performed to determine if the corresponding metamorphic feature becomes activated. Thus, when the multi-triggering symbol appears, it may be possible that one, two, three, or none of the metamorphic features associated with the multi-triggering symbol are activated. In some embodiments, one or more of the metamorphic features may have a different probability of being activated. For example, red may have the highest probability, blue may have the lowest probability, and green may have an intermediate probability. To achieve this, each RNG call to determine if the corresponding metamorphic feature may be evaluated using a different pay table or series of lookup values associated with the metamorphic feature.

In the exemplary embodiment, process 400 may further include, for each activated metamorphic feature, controlling 408 the display device to display the visual change associated with the activated metamorphic feature. As described above, examples of such visual changes may include overlays and/or changes to a background of the game display (e.g., changing images, changing colors, highlighting portions of the display, each of which may be associated with a particular metamorphic feature. In cases where multiple metamorphic features are activated, multiple visual changes may be implemented. Once activated, the metamorphic feature may remain activated for a certain, predefined period (e.g., a number of turns or number of free spins, an amount of time, and/or until a game session is ended). The visual change and game mechanic associated with the metamorphic feature may remain present during this period.

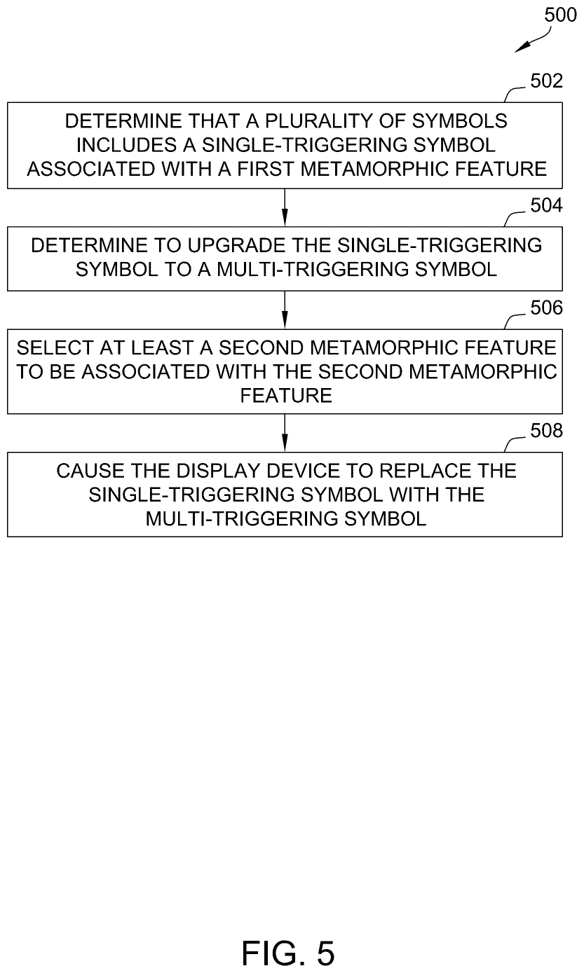

FIG. 5 is a flowchart illustrating an exemplary process 500 for electronic gaming using a multi-triggering symbol in which a single-triggering symbol may be converted or upgraded to a multi-triggering symbol. While described primarily with respect to an example of upgrading a single-triggering symbol to a multi-triggering symbol, a similar process may be used to upgrade multi-triggering symbols (e.g., from one associated with two metamorphic features to one associated with three or four metamorphic features, and so on). Process 500 may be performed in conjunction with process 400 by system 100 (shown in FIG. 1), for example, using one or more server computers 102, gaming devices 104, and/or mobile gaming devices 256 (shown in FIG. 2).

In the exemplary embodiment, process 500 may include determining 502 that a plurality of symbols of a game outcome (e.g., determined as described above with respect to process 400) includes a single-triggering symbol associated with a first metamorphic feature.

In the exemplary embodiment, process 500 may further include determining 504 to upgrade the single-triggering symbol to a multi-triggering symbol. In some embodiments, this determination may be made based on an RNG outcome. For example, for each single-triggering symbol that is displayed, and RNG call may be performed to randomly determine to upgrade the symbol. Additionally, or alternatively, the determination to upgrade the single-triggering symbol to a multi-triggering symbol may be made based on the plurality of symbols resulting in a predefined pattern. For example, if the single-triggering symbol appears within a certain line having a predefined combination of other symbols, a determination to upgrade the single-triggering symbol may be triggered.

In the exemplary embodiment, process 500 may further include, in response to determining to upgrade the single-triggering symbol to a multi-triggering symbol, selecting 506 at least a second metamorphic feature to be associated with the second metamorphic feature. For example, when it is determined to upgrade a single-determining symbol, a set of candidate metamorphic features to add may be identified. These may include, for example, all of the metamorphic features of the electronic game other than the first metamorphic feature, or some subset thereof. For each of these candidate metamorphic features, an RNG call may be performed, and the corresponding metamorphic feature may be determined to be added to the single-triggering symbol based on an outcome of the RNG call.

For example, an electronic game may have a red, a green, and a blue, metamorphic feature, and a single-triggering symbol associated with the red metamorphic feature may be displayed as part of a game outcome. If it is determined that the single-triggering symbol is eligible to be upgraded (e.g., based on an RNG call or the game outcome, as described above), a separate RNG call may be performed to determine whether to add the green metamorphic feature and the blue metamorphic feature to the single-triggering symbol. Thus, either the green metamorphic feature, the blue metamorphic feature, both, or neither may be added. Thus, another metamorphic feature may not necessarily be added even if it is initially determined that a single-triggering symbol is eligible to be upgraded. In some embodiments, a probability associated with adding a particular metamorphic feature may be different than that for adding another. For example, it may be more likely that the green metamorphic feature is added than the green metamorphic feature. To achieve this, each RNG call to determine whether to add a corresponding metamorphic feature may be evaluated using a different pay table or series of lookup values associated with the metamorphic feature.

In the example embodiment, process 500 may further include, in response to determining to upgrade the single-triggering symbol to the multi-triggering symbol, causing 508 the display device to replace the single-triggering symbol with the multi-triggering symbol. For example, if is determined that the green metamorphic feature should be added to a single-triggering symbol associated with the red metamorphic feature, the single-triggering symbol may be replaced with a multi-triggering symbol including both red and green. In some embodiments, an animation such as a wheel spin may be displayed during and/or in response to the determination to upgrade the single-triggering symbol. For example, in response to a determination to add the red metamorphic feature, a wheel spin may land on a red portion of the wheel, and then the single-triggering symbol may be modified accordingly. Once the multi-triggering symbol is displayed, it may be evaluated as described with respect to process 400 to determine whether any of the metamorphic features associated with the upgraded symbol should be activated.

FIG. 6 depicts an example game interface 600, which may be displayed for example by gaming devices 104 and/or mobile gaming devices 256 while performing process 400 and/or process 500. In the exemplary embodiment, game interface 600 includes a set of reels 602 in which a game outcome including a plurality of symbols may be displayed. The game outcome may be determined randomly, for example, by performing a lookup using one or more pay tables based on one or more RNG outcomes.

In the exemplary embodiment, game interface 600 may further include a plurality of indicators 604 associated with respective metamorphic features. In the exemplary embodiment shown in FIG. 6, game interface 600 includes four indicators 604 corresponding to four different metamorphic features. When the metamorphic features are activated, indicators 604 may change in appearance to illustrate to the user that the corresponding metamorphic feature is activated. For example, as shown in FIG. 6, each indicator 604 may include a number of bombs, the fuses of which may appear lit when the corresponding metamorphic feature is active.

In the example embodiment, one or more single-triggering symbols 606 or multi-triggering symbols 608 may displayed as part of a game outcome on reels 602. Each single-triggering symbol 606 is associated with one of indicators 604, and may have, for example, a color or other display aspect that matches that of the corresponding indicator 606. When a single-triggering symbol 604 is displayed, an RNG call may be performed to determine whether to activate the corresponding metamorphic feature and indicator 604. Each multi-triggering symbol is associated with more than one of indicators 604. For example, FIG. 6 illustrates a multi-triggering symbol 608 corresponding to four indicators 604, and which may have a color or other display aspect corresponding to each of the four indicators 604. When a multi-triggering symbol 608 is displayed, an RNG call may be performed for each corresponding metamorphic feature to determine whether to activate the corresponding metamorphic feature and indicator 604. For example, the multi-triggering symbol 608 shown in FIG. 6 may trigger four different RNG calls to determine whether to activate a respective metamorphic feature and indicator 604.

FIG. 7 depicts an example game interface 700, which may be displayed for example by gaming devices 104 and/or mobile gaming devices 256 while performing process 400 and/or process 500. In the exemplary embodiment, game interface 700 includes a set of reels 702 and indicators 704, which may function similarly to the reels 602 and indicators 604 shown in FIG. 6, respectively. In the example embodiment shown in FIG. 7, game interface 700 includes three indicators 704 corresponding to three different metamorphic features. A shown for example in FIG. 7, each indicator 704 may include a number of fire crackers, the fuses of which may appear lit when the corresponding metamorphic feature is active.

In the example embodiment, one or more single-triggering symbols 706 may displayed as part of a game outcome on reels 702. Each of single-triggering symbols 706 is associated with one of indicators 704 and the corresponding metamorphic feature. As described above with respect to process 500, in the exemplary embodiment, single-triggering symbols 706 may be converted or upgraded to multi-triggering symbols similar to multi-triggering symbol 608 (shown in FIG. 6) that are associated with multiple indicators 704 and corresponding metamorphic features. For example, an RNG call and/or other determination (e.g., based on the displayed game outcome) may be performed for each displayed single-triggering symbols 706 to determine if the single-triggering symbols 706 is eligible to be upgraded, and one or more additional RNG calls and/or other determinations may be performed to determine which metamorphic features to add. Once it is determined which, if any, metamorphic features are to be added, an appearance of single-triggering symbols 706 may be altered to include display aspects (e.g., colors) associated with each of the metamorphic features and corresponding indicators 704.

In some embodiments, game interface 700 further includes a wheel 708 or other element that may indicate to the user when and how a single-triggering symbol 706 or other triggering symbol is being upgraded. For example, wheel 708 may include sectors corresponding to different colors, and if it is determined to upgrade one of single-triggering symbols 706 is to be upgraded to include a certain additional color, wheel 708 may spin for a period of time, and a color on which wheel 708 lands when wheel 708 stops spinning may be the color added to single-triggering symbols 706. In alternative embodiments, other types of indicators or display sequences, such as a separate or overlay reel outcome or a bonus game, may be used to illustrate when and how a single-triggering symbols 706 is being upgraded.

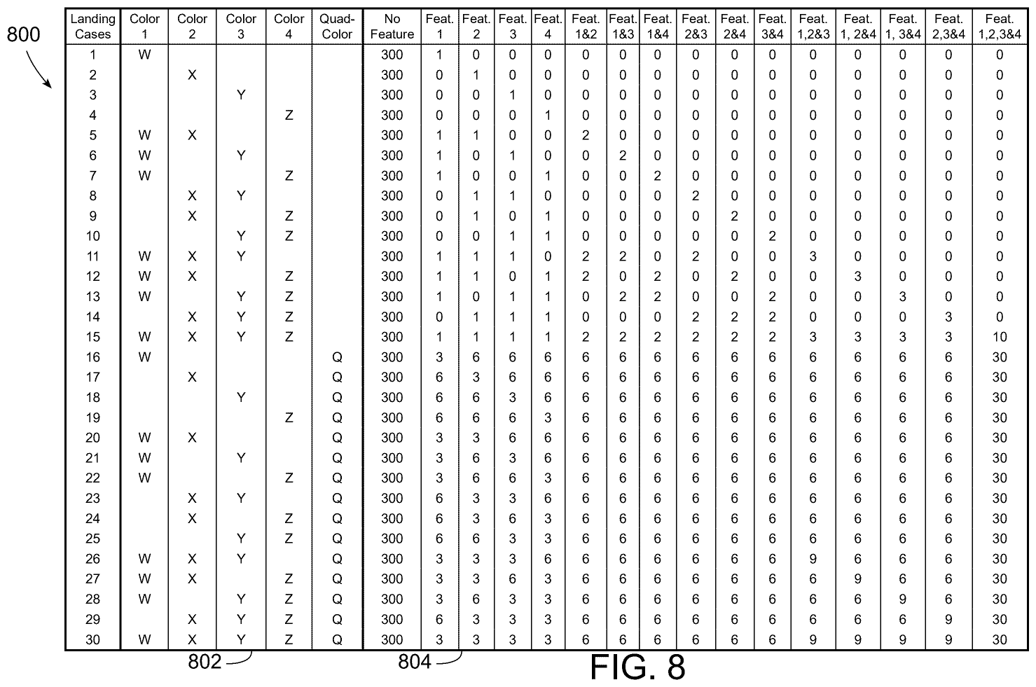

FIG. 8 depicts an exemplary weighted table 800 which may be used, for example, to determine whether to activate different metamorphic features. In the example illustrated in FIG. 8, a game may include four metamorphic features (“Feature 1,” “Feature 2,” “Feature 3,” and “Feature 4”) each corresponding to a respective color and type of single-triggering symbol 606 (“Color 1,” “Color 2,” “Color 3,” and “Color 4”) that may be displayed with a corresponding count (“W,” “X,” “Y,” and “Z”) during a game outcome. Additionally, a multi-triggering symbol 608 (“Quad Color”) corresponding to each of the four colors may be displayed with a corresponding count (“Q”).

As shown in FIG. 8, there may be thirty different combinations 802 in which one of Color 1, Color 2, Color 3, Color 4, or Quad Color are displayed during a game outcome. For each combination 802, there are a series of weights 804 based on which it may be determined which combination of Feature 1, Feature 2, Feature 3, and Feature 4 are activated. A zero weight indicates that a corresponding feature is not possible to be triggered, while non-zero weights correspond to a chance of triggering the corresponding feature. The exact value of weights for each feature may be either predefined constant numbers, or may be a function of the symbol counts W, X, Y, Z, Q. In other words, the weights may be selected so that a feature is more likely to trigger if more counts of that trigger symbol land in the game outcome. In cases in which at least one Quad Color trigger symbols is displayed (Landing Cases 16-30), the weights 804 in the last column in table 800 may be selected to achieve a desired frequency of all four metamorphic features being activated.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A system for electronic gaming comprising:
at least one memory device; and
at least one processor in communication with the memory device, the at least one processor configured to:
generate a first random outcome for a first reel of an electronic game, the first random outcome including a single-triggering symbol associated with a first metamorphic feature;
generate a second random outcome for a second reel of the electronic game, the second random outcome including a multi-triggering symbol, the multi-triggering symbol associated with the first metamorphic feature and at least one other metamorphic feature, each of the metamorphic features associated with a visual change in the electronic game indicating the metamorphic feature is active;
for each of the metamorphic features associated with the multi-triggering symbol, determine whether to activate the metamorphic feature based on a respective random number generator (RNG) outcome;
for the first metamorphic feature associated with the single-triggering symbol, determine whether to activate the first metamorphic feature based on a respective RNG outcome; and
for each activated metamorphic feature, control a display device to display the visual change associated with the activated metamorphic feature based on the respective RNG outcomes.

2. The system of claim 1, wherein the multi-triggering symbol is associated with two metamorphic features, three metamorphic features, or four metamorphic features.

3. The system of claim 1, wherein the at least one processor is further configured to:
determine that the first random outcome includes the single-triggering symbol associated with a first metamorphic feature; and
determine to upgrade the single-triggering symbol to a multi-triggering symbol.

4. The system of claim 3, wherein the processor is configured to determine to upgrade the single-triggering symbol to the multi-triggering symbol based on an RNG outcome.

5. The system of claim 3, wherein the processor is configured to determine to upgrade the single-triggering symbol to the multi-triggering symbol based on the first random outcome resulting in a predefined pattern.

6. The system of claim 3, wherein the processor is further configured to, in response to determining to upgrade the single-triggering symbol to the multi-triggering symbol, select at least a second metamorphic feature to be associated with the second metamorphic feature.

7. The system of claim 6, wherein the processor is further configured to select the second metamorphic feature based on the first random outcome.

8. The system of claim 3, wherein the processor is further configured to, in response to determining to upgrade the single-triggering symbol to the multi-triggering symbol, cause the display device to replace the single-triggering symbol with the multi-triggering symbol.

9. The system of claim 1, wherein the multi-triggering symbol includes a display aspect associated with each metamorphic feature associated with the multi-triggering symbol.

10. The system of claim 9, wherein the display aspect includes a color corresponding to with the metamorphic feature associated with the display aspect.

11. At least one non-transitory computer-readable storage media having computer-executable instructions embodied thereon, wherein when executed by at least one processor in communication with at least one memory device, the computer-executable instructions cause the at least one processor to:
generate a random outcome for an electronic game, the random outcome including a single-triggering symbol associated with a first metamorphic feature and a multi-triggering symbol, the multi-triggering symbol associated with the first metamorphic feature and at least one other metamorphic feature, each of the metamorphic features associated with a visual change in the electronic game indicating the metamorphic feature is active;
for each of the metamorphic features associated with the multi-triggering symbol included in the random outcome, determine whether to activate the metamorphic feature based on a respective random number generator (RNG) outcome;
for the first metamorphic feature associated with the single-triggering symbol included in the random outcome, determine whether to activate the first metamorphic feature based on a respective RNG outcome; and
for each activated metamorphic feature, control a display device to display the visual change associated with the activated metamorphic feature based on the respective RNG outcomes.

12. The at least one non-transitory computer-readable storage media of claim 11, wherein the multi-triggering symbol is associated with two metamorphic features, three metamorphic features, or four metamorphic features.

13. The method of claim 11, wherein the computer-executable instructions further cause the at least one processor to:
determine that the first random outcome includes the single-triggering symbol associated with a first metamorphic feature; and
determine to upgrade the single-triggering symbol to a multi-triggering symbol.

14. The at least one non-transitory computer-readable storage media of claim 13, wherein the computer-executable instructions further cause the at least one processor to determine to upgrade the single-triggering symbol to the multi-triggering symbol based on an RNG outcome.

15. The at least one non-transitory computer-readable storage media of claim 13, wherein the computer-executable instructions further cause the at least one processor to determine to upgrade the single-triggering symbol to the multi-triggering symbol based on the random outcome resulting in a predefined pattern.

16. The at least one non-transitory computer-readable storage media of claim 13, wherein the computer-executable instructions further cause the at least one processor to, in response to determining to upgrade the single-triggering symbol to the multi-triggering symbol, select at least a second metamorphic feature to be associated with the second metamorphic feature.

17. The at least one non-transitory computer-readable storage media of claim 16, wherein the computer-executable instructions further cause the at least one processor to select the second metamorphic feature based on the random outcome.

18. The at least one non-transitory computer-readable storage media of claim 13, wherein the computer-executable instructions further cause the at least one processor to, in response to determining to upgrade the single-triggering symbol to the multi-triggering symbol, cause the display device to replace the single-triggering symbol with the multi-triggering symbol.

19. The at least one non-transitory computer-readable storage media of claim 11, wherein the multi-triggering symbol includes a display aspect associated with each metamorphic feature associated with the multi-triggering symbol.

20. A method for electronic gaming, the method comprising:
generating a random outcome for an electronic game, the random outcome including a single-triggering symbol associated with a first metamorphic feature and a multi-triggering symbol, the multi-triggering symbol associated with the first metamorphic feature and at least one other metamorphic feature, each of the metamorphic features associated with a visual change in the electronic game indicating the metamorphic feature is active;
for each of the metamorphic features associated with the multi-triggering symbol included in the random outcome, determining whether to activate the metamorphic feature based on a respective random number generator (RNG) outcome;
for the first metamorphic feature associated with the single-triggering symbol included in the random outcome, determining whether to activate the first metamorphic feature based on a respective RNG outcome; and
for each activated metamorphic feature, controlling a display device to display the visual change associated with the activated metamorphic feature based on the respective RNG outcomes.
